(19) United States
(12) Patent Application Publication
(10) Pub. No.: US 2017/0167739 A1
(43) Pub. Date: Jun. 15, 2017

(54) Portable Humidification Device

(71) Applicant: Michael Williams, Sarasota, FL (US)

(72) Inventor: Michael Williams, Sarasota, FL (US)

(21) Appl. No.: 14/964,063

(22) Filed: Dec. 9, 2015

(51) Int. Cl. F24F 6/02; H05B 3/00; H05B 1/02

(52) U.S. Cl. CPC F24F 6/025; H05B 1/0297; H05B 3/0014

(57) ABSTRACT

A portable humidification device for portable humidification purposes includes a housing that comprises a wall extending upwardly from a bottom of the housing defining an open top. The device includes a lid that is both complimentary to and couplable to the open top. A plurality of holes is positioned through the lid. A vaporizer is coupled to a lower surface of the lid. The open top is configured to add water to the housing, wherein the lid is positionable into the open top. The vaporizer is positioned to vaporize the water, wherein the water vapor is emitted from the housing through the plurality of holes.

### BACKGROUND OF THE DISCLOSURE

### Field of the Disclosure

The disclosure relates to humidification devices and more particularly pertains to a new humification device for portable humidification purposes.

### SUMMARY OF THE DISCLOSURE

An embodiment of the disclosure meets the needs presented above by generally comprising a housing that comprises a wall extending upwardly from a bottom of the housing defining an open top. The device includes a lid that is both complimentary to and couplable to the open top. A plurality of holes is positioned through the lid. A vaporizer is coupled to a lower surface of the lid. The open top is configured to add water to the housing, wherein the lid is positionable into the open top. The vaporizer is positioned to vaporize the water, wherein the water vapor is emitted from the housing through the plurality of holes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a portable humidification device according to an embodiment of the disclosure.

FIG. 2 is a cross-sectional view of an embodiment of the disclosure.

FIG. 3 is a top view of an embodiment of the disclosure.

FIG. 4 is a detail view of an embodiment of the disclosure.

### DESCRIPTION OF THE PREFERRED EMBODIMENT

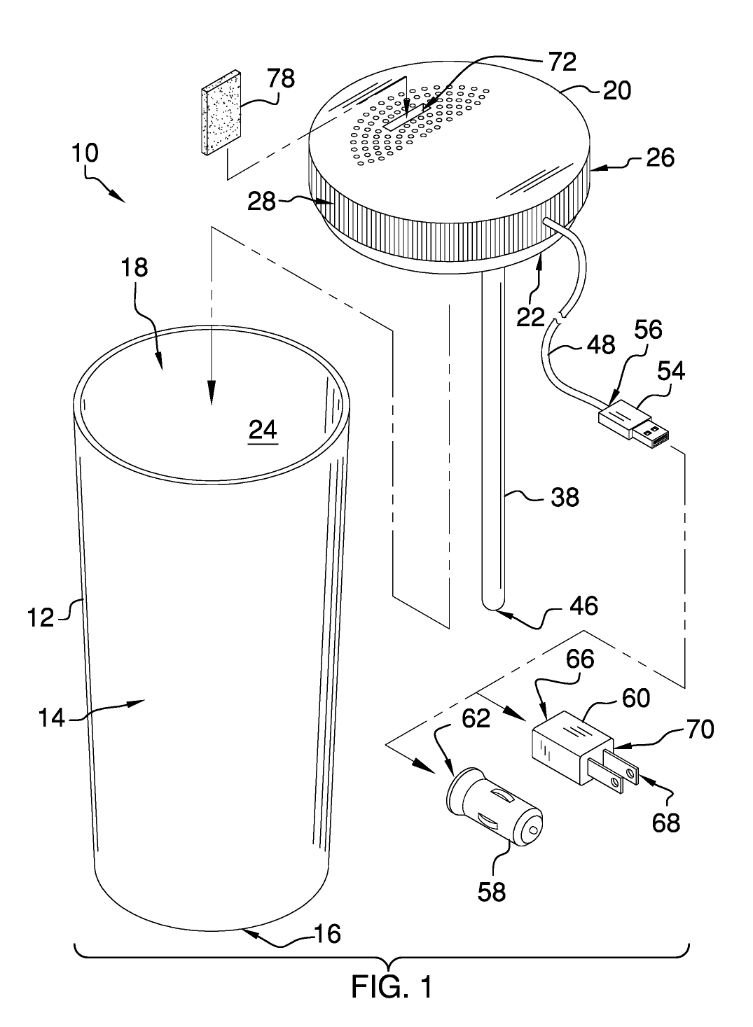

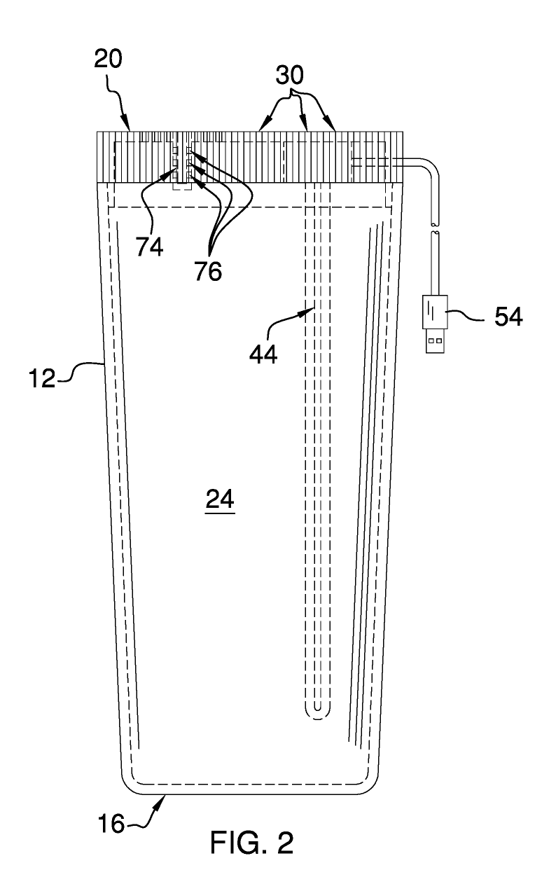

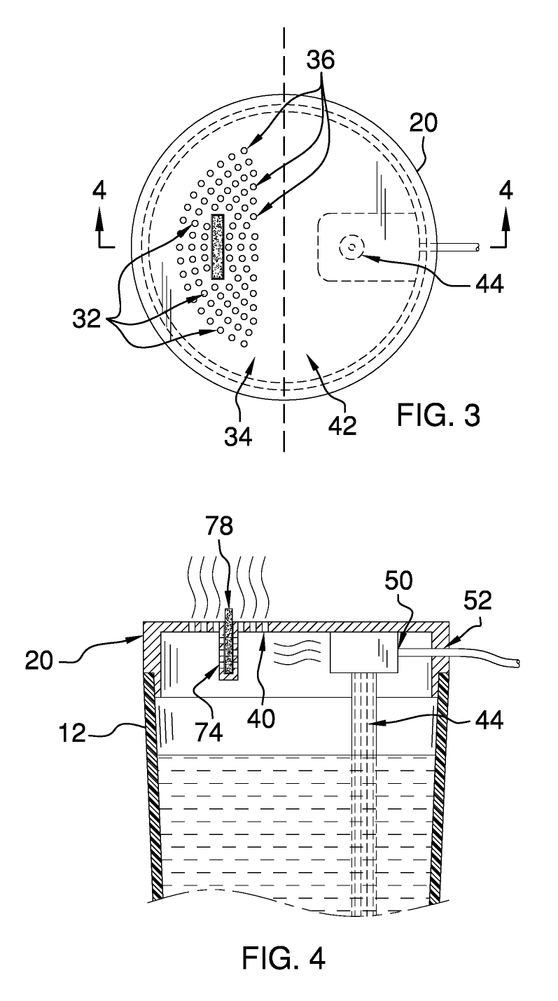

With reference now to the drawings, and in particular to FIGS. 1 through 4 thereof, a new humidification device embodying the principles and concepts of an embodiment of the disclosure and generally designated by the reference numeral 10 will be described.

As best illustrated in FIGS. 1 through 4, the portable humification device 10 generally comprises a housing 12 that comprises a wall 14 extending upwardly from a bottom 16 of the housing 12, defining an open top 18. Preferably, the bottom 16 is circular such that the housing 12 is cylindrical. The device 10 includes a lid 20 that is both complimentary to and couplable to the open top 18. The lid 20 has a recessed edge 22 that is in contact with an interior surface 24 of the housing 12 when the lid 20 is placed on the open top 18, such that the lid 20 is frictionally coupled to the housing 12. The lid 20 has an annular edge 26 that comprises a grip 28. Preferably, the grip 28 comprises a plurality of vertical groves 30. A plurality of holes 32 is positioned through the lid 20. Preferably, the holes 32 are round and positioned in a first half 34 of the lid 20. The holes 32 may be arrayed in a plurality of arches 36.

A vaporizer 38 is coupled to a lower surface 40 of the lid 20. Preferably, the vaporizer 38 is positioned on the lower surface 40 of a second half 42 of the lid 20. More specifically, the vaporizer 38 comprises a heating element 44, a power cord 48 and a male universal serial bus connector 54. The heating element 44 is coupled to the lid 20, such that the heating element 44 extends from the lower surface 40 of the lid 20 to proximate to the bottom 16 of the housing 12 when the lid 20 is positioned in the open top 18. Preferably, the heating element 44 is cylindrical and has a rounded end 46. The power cord 48 has a first end 50 operationally coupled to the heating element 44 proximate to the lid 20. The power cord 48 extends from the heating element 44 through an orifice 52 positioned in the annular edge 26. The male universal serial bus connector 54 is coupled to a second end 56 of the power cord 48.

The device 10 also includes a 12V accessory outlet plug 58 and an inverter adapter 60. The 12V accessory outlet plug 58 has a universal serial bus port 62, such that the universal serial bus port 62 is positioned to couple with the male universal serial bus connector 54. As such, the vaporizer 38 is couplable to a direct current source.

The inverter adapter 60 is couplable by a female end 66 to the male universal serial bus connector 54 and by a male end 68 to an alternating current source. The male end 68 is selected from the group of plug types consisting of plug Types A, B, C, D, E, F, G, H, I, J, K, L, M, N, and O. Preferably, the male end 68 comprises a Type B plug 70. The female end 66 is positioned to couple with the male universal serial bus connector 54 such that the vaporizer 38 is couplable to an alternating current source.

A penetration 72 is positioned in the first half 34 of the lid 20. The penetration 72 is rectangular. A compartment 74 is coupled to the lower surface 40 of the lid 20. The compartment 74 is positioned beneath the penetration 72. The compartment 74 is rectangularly box shaped.

A plurality of openings 76 is positioned in the compartment. The penetration 72 is positioned for the user to insert a strip 78 into the compartment 74. The strip 78 is infusible.

In use, the open top 18 is configured for the user to add water to the housing 12. The lid 20 is positionable into the open top 18, such that the heating element 44 is contacted with the water. The power cord 48 is configured to supply power to the heating element 44 to vaporize the water. The water vapor is emitted from the housing 12 through the plurality of holes 32. Some of the water vapor enters the compartment 74 through the plurality of openings 76, contacting the strip 78, and exits through the penetration 72. The strip 78 is configured to be infused as desired by the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A portable humidification device comprising:
a housing, said housing comprising a wall extending upwardly from a bottom of said housing defining an open top;
a lid, said lid being complimentary to said open top, said lid being couplable to said open top;
a plurality of holes, said plurality of holes being positioned through said lid;
a vaporizer, said vaporizer being coupled to a lower surface of said lid; and
wherein said open top is configured for addition of water to said housing, wherein said lid is positionable into said open top, such that said vaporizer is positioned to vaporize the water, wherein the water vapor is emitted from said housing through said plurality of holes.

2. The device of claim 1, further including said bottom being circular such that said housing is cylindrical.

3. The device of claim 1, further including said lid having a recessed edge, said recessed edge being in contact with an interior surface of said housing when said lid is placed on said open top, wherein said lid is frictionally coupled to said housing.

4. The device of claim 1, further including said lid having an annular edge, said annular edge comprising a grip.

5. The device of claim 4, further including said grip comprising a plurality of vertical groves.

6. The device of claim 1, further including said holes being round.

7. The device of claim 1, further including said holes being positioned in a first half of said lid.

8. The device of claim 1, further including said holes being arrayed in a plurality of arches.

9. The device of claim 1, further including said vaporizer being positioned on said lower surface of a second half of said lid.

10. The device of claim 1, further including said vaporizer comprising:
a heating element, said heating element being coupled to said lid, such that said heating element extends from said lower surface of said lid to proximate to said bottom of said housing when said lid is positioned in said open top;
a power cord, said power cord having a first end operationally coupled to said heating element proximate to said lid; and
a male universal serial bus connector, said connector being coupled to a second end of said power cord.

13. The device of claim 10, further including said heating element being cylindrical and having a rounded end.

14. The device of claim 10, further including said power cord extending from said heating element through an orifice positioned in an annular edge of said lid.

15. The device of claim 10, further including a 12V accessory outlet plug, said 12V accessory outlet plug having a universal serial bus port, wherein said universal serial bus port is positioned to couple with said male universal serial bus connector such that said vaporizer is couplable to a direct current source.

16. The device of claim 10, further including an inverter adapter, said inverter adapter being couplable by a female end to said male universal serial bus connector and by a male end to an alternating current source.

17. The device of claim 16, further including said male end being selected from the group of plug types consisting of plug Types A, B, C, D, E, F, G, H, I, J, K, L, M, N, and O, wherein said female end is positioned to couple with said male universal serial bus connector such that said vaporizer is couplable to an alternating current source.

18. The device of claim 17, further including said male end comprising a Type B plug.

19. The device of claim 1, further comprising:
a penetration, said penetration being positioned in a first half of said lid, said penetration being rectangular;
a compartment, said compartment being coupled to said lower surface of said lid, said compartment being positioned beneath said penetration, said compartment being rectangularly box shaped;
a plurality of openings, said openings being positioned in said compartment, wherein said penetration is positioned for insertion of a strip; and
said strip being infusible.

20. A portable humidification device comprising:
a housing, said housing comprising a wall extending upwardly from a bottom of said housing defining an open top, said bottom being circular such that said housing is cylindrical;
a lid, said lid being complimentary to said open top, said lid being couplable to said open top, said lid having a recessed edge, said recessed edge being in contact with an interior surface of said housing when said lid is placed on said open top, wherein said lid is frictionally coupled to said housing, said lid having an annular edge, said annular edge comprising a grip, said grip comprising a plurality of vertical groves;
a plurality of holes, said plurality of holes being positioned through said lid, said holes being round, said holes being positioned in a first half of said lid, said holes being arrayed in a plurality of arches;
a vaporizer, said vaporizer being coupled to a lower surface of said lid, said vaporizer being positioned on said lower surface of a second half of said lid;
said vaporizer comprising:
a heating element, said heating element being coupled to said lid, such that said heating element extends from said lower surface of said lid to proximate to said bottom of said housing when said lid is positioned in said open top, said heating element being cylindrical and having a rounded end,
a power cord, said power cord having a first end operationally coupled to said heating element proximate to said lid, said power cord extending from said heating element through an orifice positioned in said annular edge, and
a male universal serial bus connector, said connector being coupled to a second end of said power cord;
a 12V accessory outlet plug, said 12V accessory outlet plug having a universal serial bus port, wherein said universal serial bus port is positioned to couple with said male universal serial bus connector such that said vaporizer is couplable to a direct current source;
an inverter adapter, said inverter adapter being couplable by a female end to said male universal serial bus connector and by a male end to an alternating current source, said male end being selected from the group of plug types consisting of plug Types A, B, C, D, E, F, G, H, I, J, K, L, M, N, and O, wherein said female end is positioned to couple with said male universal serial bus connector such that said vaporizer is couplable to an alternating current source, said male end comprising a Type B plug;
a penetration, said penetration being positioned in said first half of said lid, said penetration being rectangular;
a compartment, said compartment being coupled to said lower surface of said lid, said compartment being positioned beneath said penetration, said compartment being rectangularly box shaped;
a plurality of openings, said openings being positioned in said compartment, wherein said penetration is positioned for insertion of a strip, said strip being infusible; and
wherein said open top is configured for addition of water to said housing, wherein said lid is positionable into said open top, such that said heating element is contacted with the water and wherein said power cord is configured to supply power to said heating element to vaporize the water, wherein the water vapor is emitted from the housing through said plurality of holes, and such that some of the water vapor enters said compartment through said plurality of openings and exits through said penetration, and wherein said strip is configured to be infused as desired by the user.
